(19) United States
(12) Patent Application Publication
(10) Pub. No.: US 2026/0105505 A1
(43) Pub. Date: Apr. 16, 2026

(54) UNIFIED PLATFORM FOR AUTOMOBILE-RELATED SERVICES

(71) Applicant: GLOBAL ADVANCED PRODUCTS lNC., West Vancouver (CA)

(72) Inventor: KOOHYAR FARBOUD, West Vancouver (CA)

(73) Assignee: GLOBAL ADVANCED PRODUCTS lNC., West Vancouver (CA)

(21) Appl. No.: 19/358,404

(22) Filed: Oct. 14, 2025

(30) Foreign Application Priority Data
Oct. 15, 2024 (CA) 3252115

(51) Int. Cl. G06Q 30/0601; G06F 16/29; G06Q 10/1053; G06Q 10/20; G06Q 30/08; G06Q 40/02; G06Q 50/10

(52) U.S. Cl. CPC G06Q 30/0627; G06F 16/29; G06Q 10/1053; G06Q 10/20; G06Q 30/08; G06Q 40/026; G06Q 50/10

(57) ABSTRACT

The present disclosure discloses a system for providing a unified platform for automobile-related services. The system comprises a server comprising a database to store data related to automobile services, said services selected from automobile auction services, automobile marketing services, automobile event management services, automobile job posting services, automobile transportation services, automobile body repair services, and automobile financing services. The system further comprises a computing device operatively connected to said server via a communication network, wherein the computing device receives a keyword-based search query from a user, wherein the user is selected from a business-to-business automobile market type. Said server receives the keyword-based search query from the computing device, performs the search within the database to fetch data related to the automobile services, and transmits said data to the computing device.

### TECHNICAL FIELD

The present disclosure generally relates to platforms for automobile-related services. Further, the present disclosure particularly relates to a unified platform for providing automobile-related services for business-to-business (B2B) users, business-to-customer (B2C) users, customer-to-customer (C2C) users, and customer-to-business (C2B) users.

### BACKGROUND

Automobile-related services are integral to various sectors within the automobile industry. Such services encompass auctions, marketing, event management, job postings, transportation, body repair, and financing. Presently, multiple platforms or systems provide access to these services, leading to fragmented data access and operational inefficiencies. Users often rely on different platforms to obtain necessary information, which complicates the process and introduces delays in accessing services related to the automobile industry.

Several existing systems offer specialized platforms focusing on specific services, such as auction or marketing platforms. While such systems fulfill their respective roles, said systems lack the ability to integrate multiple automobile-related services under a single platform. The fragmentation forces users to switch between different systems, creating inefficiencies in accessing relevant data. Furthermore, such systems often possess limited search capabilities, restricting the retrieval of an information across various services, which leads to further operational difficulties.

Other systems provide limited integration of services but fail to cover the full spectrum of automobile-related services. For instance, systems offering auction and marketing services may exclude event management or job postings, creating incomplete solutions for business-to-business (B2B) markets. Moreover, the search capabilities within such systems are often restricted to specific services, resulting in inefficient data retrieval. As a result, users experience gaps in data access, especially when searching for diverse services across the automobile industry.

Additionally, some systems lack effective keyword-based search functionalities and real-time synchronization, further complicating data retrieval. The absence of data synchronization results in incomplete or outdated information, which negatively impacts the user experience. As a result, B2B users face challenges in accessing relevant data, limiting the effectiveness of existing platforms in providing seamless access to automobile-related services.

In light of the above discussion, there exists an urgent need for solutions that overcome the problems associated with conventional systems and/or techniques for providing a unified platform for automobile-related services.

### SUMMARY

In an aspect, the present disclosure provides a system for providing a unified platform for automobile-related services. The system comprises a server containing a database to store data related to various automobile services, said services comprising auction services, marketing services, event management services, job posting services, transportation services, body repair services, and financing services. The system further comprises a computing device operatively connected to said server via a communication network, wherein the computing device receives a keyword-based search query from a user. Said user is selected from a business-to-business automobile market type. The server receives the keyword-based search query from the computing device, performs a search within the database to fetch data related to the automobile services, and transmits such data to the computing device.

The system enables keyword-based search queries to integrate a map feature. Said map feature is linked with the database to display geographical locations of automobile services relevant to the keyword-based search query. The map feature enables users to locate specific services with respect to geographical location, optimizing the user experience.

Moreover, the system comprises a virtual office dedicated to each user. Said virtual office allows the user to monitor and manage automobile-related activities through defined menus and submenus, comprising a transaction and invoice menu. The transaction and invoice menu comprises a transaction notice tab, an invoice tab, and a statement tab. A virtual bank account is assigned to each user, allowing real-time monitoring of financial activities, such as credit card payments, electronic funds transfers, or pre-authorized debits.

In another aspect, the system offers an automobile auction platform. Said auction platform notify users of status during auction stages, inform users of time remaining in an auction stage, and guide users through tasks for subsequent auction stages. The auction platform also comprises an auto-bidding feature, which enables users to set a maximum bid and automatically submit bids without user interaction in real-time. The system halts bidding when the maximum bid is exceeded and provides an automated mediation process to resolve claims regarding undisclosed vehicle damage.

In an embodiment, the system further integrates a geolocation module with the database, enabling an open geolocation-based platform that allows users to locate automobile services based on geographical data related to keyword-based search queries. Said geolocation module enhances the user experience by providing real-time, location-specific information on services.

In an embodiment, the system also provides job posting and application services, enabling companies to post job offers in the automobile industry, and candidates to view and apply for said job offers without geolocation restrictions. A communication interface is provided for real-time interaction between companies and candidates.

Additionally, the system comprises automobile event promotion services. Said services enable automobile companies to promote internal events, automobile launches, and promotions, and provide users with the ability to search and view events without geolocation restrictions. The system also facilitates navigation through said events for ease of access.

In another aspect, the system offers automobile transportation and body repair request services. Users are enabled to post requests for transportation or body repair services without geolocation restrictions, while companies can browse and provide quotes based on location. The system comprises a real-time communication interface for users and companies to discuss service details.

Furthermore, the system offers automobile financing services. Said financing services allow users to submit automobile finance requests through a digital form, which dealerships can then search, view, and respond to without any geolocation restrictions.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a system 100 for providing a unified platform for automobile-related services, in accordance with the embodiments of the present disclosure;

FIG. 2 depicts a process flow diagram of the system 100 for providing a unified platform for automobile-related services, in accordance with the embodiments of the present disclosure;

FIG. 3 illustrates an exemplary graphical user interface (GUI) as part of the system 100 for providing a unified platform for automobile-related services;

FIG. 4 illustrates an exemplary user interface (UI) depicting multiple automobile related services, in accordance with the embodiments of the present disclosure;

FIG. 5 depicts an exemplary user interface (UI) depicting auction-related services, in accordance with the embodiments of the present disclosure;

FIG. 6 depicts exemplary user interfaces (UIs) that illustrate the initial procedures involved in the auction process, in accordance with the embodiments of the present disclosure;

FIG. 7 depicts an exemplary tabular arrangement outlining various seller penalties and deposit statuses in auction transactions, in accordance with the embodiments of the present disclosure;

FIG. 8 depicts exemplary user interfaces (UIs) for managing post-auction vehicle pick-up and delivery, in accordance with the embodiments of the present disclosure;

FIG. 9 depicts exemplary user interfaces (UIs) related to vehicle delivery after an auction, in accordance with the embodiments of the present disclosure; and

FIG. 10 depicts exemplary user interfaces (UIs) related to the mediation process following an auction, in accordance with the embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, the term “server” refers to a centralized computing unit that hosts the database and processes the data related to automobile services. The server handles the core functionalities of receiving keyword-based search queries from users and performing corresponding searches within the database. Upon retrieving the required data from the database, the server sends the retrieved data back to the computing device operated by the user. The server is directly connected to the communication network, which links the server with the computing device of user, assuring real-time interaction between different components of the system. The server facilitates data retrieval and transmission, enabling users to access an information regarding automobile auctions, marketing, event management, job postings, transportation, body repair, and financing services stored within the database.

As used herein, the term “database” refers to a structured storage unit hosted on the server that stores information related to automobile services. The database comprises data related to various categories of services such as auctions, marketing, event management, job postings, transportation, body repair, and financing. The server accesses the database to retrieve data when a user submits a keyword-based search query. The database allows fast and accurate data retrieval by the server in response to user queries. The data stored in the database supports the various services offered by the system and is organized to enable efficient searching and sorting.

As used herein, the term “computing device” refers to an electronic device operated by the user, which communicates with the server through a communication network. The computing device is the primary interface for users to interact with the system, allowing the submission of keyword-based search queries and the reception of data from the server. The computing device is selected from laptops, smartphones, or desktop computers and is operatively connected to the server to assure seamless data transfer. Through the computing device, users access services such as auctions, marketing, event management, job postings, transportation, body repair, and financing. The computing device enables users to perform searches, view results, and manage various automobile-related activities provided by the system.

As used herein, the term “communication network” refers to the infrastructure that facilitates data transfer between the computing device and the server. The communication network connects the various components of the system, allowing the server to receive keyword-based search queries from the computing device, retrieve the necessary data from the database, and transmit the data back to the computing device. The communication network can wired or wireless technologies, depending on the specific implementation, and is essential for maintaining connectivity between the server and the computing device.

As used herein, the term “keyword-based search query” refers to a specific type of search request submitted by the user through the computing device. The query consists of keywords related to automobile services that the user wishes to locate. After receiving query, the server searches the database for data matching the keywords and returns the relevant information to the computing device. The keyword-based search query enables the user to quickly and efficiently find the specific automobile services selected from auctions, marketing, event management, job postings, transportation, body repair, and financing.

As used herein, the term “map feature” refers to a tool integrated within the system, which visually displays the geographical locations of automobile services based on a keyword-based search query. The map feature works in conjunction with the database, retrieving geographical data related to services such as auctions, marketing, event management, and transportation. Once the relevant locations are retrieved, the map feature presents the information visually on the computing device. The map feature allows users to understand where services are located relative to their geographical preferences, offering an intuitive way to search for location-based automobile services.

As used herein, the term “automobile auction platform” or “auction platform” refers to an integrated feature within the system that facilitates online automobile auctions. The auction platform allows users to participate in auctions by providing notifications about their current status during different auction stages. The platform informs users of the time remaining in each auction stage and provides guidance on the tasks to be completed for the next stage. The platform also associated with an auto-bidding tool, allowing users to set a maximum bid and submit bids automatically without needing to monitor the auction in real-time. When the maximum bid is exceeded, the platform halts further bids.

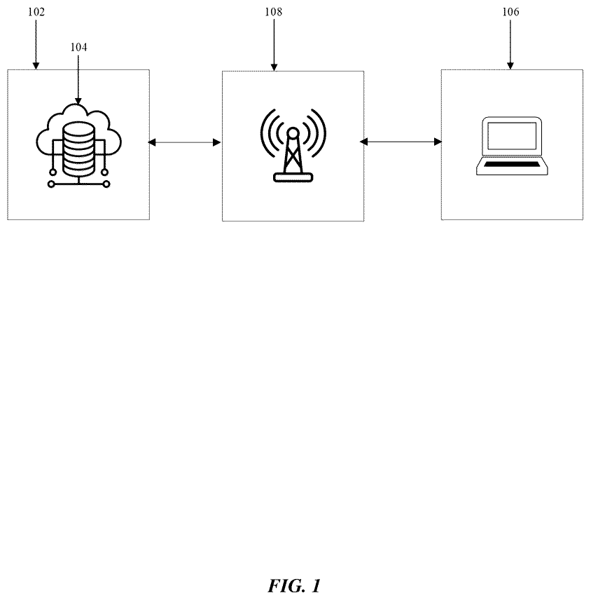

FIG. 1 illustrates a system 100 for providing a unified platform for automobile-related services, in accordance with the embodiments of the present disclosure. The system 100 comprises a server 102 that host a database 104 for storing data related to a variety of automobile services. The database 104 stores data related to services such as automobile auction services, automobile marketing services, automobile event management services, automobile job posting services, automobile transportation services, automobile body repair services, and automobile financing services. The database 104 allows for efficient storage and retrieval of information concerning said automobile-related services. The server 102 manages access to and retrieval of said data upon request from authorized users. The server 102 handles large volumes of data and manages the interaction between the stored data and users requesting access. The server 102 interacts with other components of the system 100 to facilitate the real-time sharing of information related to automobile services across various sectors of the automobile industry.

In an embodiment, the system 100 further comprises a computing device 106 operatively connected to the server 102 via a communication network 108. The computing device 106 allows users to access the system 100 remotely. Users may be business-to-business (B2B) participants within the automobile market, such as dealerships, auction houses, service providers, or other entities requiring access to automobile-related services. The computing device 106 receives keyword-based search queries from users, which relate to automobile-related services stored in the database 104. Once the computing device 106 receives the query from the user, said computing device 106 interacts with the server 102 via the communication network 108 to initiate the retrieval process of the data stored in the database 104. The computing device 106 can any type of computing hardware capable of connecting to the server 102, comprising personal computers, smartphones, tablets, or any device capable of handling real-time data transmission and query processing.

In an embodiment, the communication network 108 that links the computing device 106 to the server 102 supports the transmission of keyword-based search queries and facilitates the retrieval of data from the server 102. The communication network 108 operates in real-time and enables uninterrupted communication between the server 102 and the computing device 106. The system 100 relies on the communication network 108 to affirm the exchange of information between users and the database 104, allowing access to automobile-related services without delay. The communication network 108 can be internet, intranets, or other dedicated communication lines that support data transmission. Through the communication network 108, the computing device 106 maintains a connection with the server 102, allowing users to continually interact with the system 100 as searches are conducted or automobile-related information is retrieved.

In an embodiment, upon receiving the keyword-based search query from the computing device 106, the server 102 processes the query and performs a search within the database 104 to locate data that matches the query. The server 102 parses the query and compares said query against stored data in the database 104 to find relevant results that match the search criteria. The keyword-based search query can pertain to various automobile services, such as auction services, marketing services, event management services, and other services stored within the database 104. The server 102 applies the search parameters provided in the query to the database 104 to extract the most relevant data. The search process can be fast and efficient, given the volume of data stored in the database 104 and the need to retrieve pertinent information promptly.

In an embodiment, once the server 102 has located relevant data based on the keyword-based search query, said server 102 transmits the data to the computing device 106 for display to the user. The data retrieved from the database 104 is transmitted back through the communication network 108 to the computing device 106, where the user can view the search results. The system 100 transmits all data related to the automobile services specified in the search query, allowing the user to access information directly through the computing device 106.

In an embodiment, the system 100 manages business-to-business interactions within the automobile industry. Users of the system 100 are typically entities engaged in providing or accessing automobile services. These entities use the system 100 to manage interactions within the market by accessing services such as auctions, marketing, event management, job postings, transportation, body repair, and financing. The system 100 provides a unified platform through which users can perform various tasks related to their business activities within the automobile industry. The system 100 centralizes these interactions, enabling access to multiple services that would otherwise require separate platforms or service providers.

In an embodiment, the system 100 is also structured to receive and process complex keyword-based search queries from users, allowing searches based on specific criteria related to the automobile services stored in the database 104. For example, a user searching for auction services can use a keyword-based search query to locate data within the database 104 related to specific types of auctions or events. Similarly, a user looking for marketing services can input a query that retrieves relevant marketing information stored in the database 104. The keyword-based search feature allows users to narrow down their searches and find the exact automobile-related services required.

In an embodiment, the system 100 can manage data from various categories of automobile services such as information on pricing, availability, event scheduling, job postings, transportation requests, and financing options. Each category of service is stored in the database 104 and can be accessed by users through the system 100 based on their specific needs. For instance, a user may wish to view available options for body repair services in a specific region. The system 100 allows the user to input a keyword-based search query that filters the database 104 for relevant body repair services based on the specified criteria. The system 100 retrieves the required data and displays the retrieved data on the computing device 106 for the review of user.

Additionally, the interaction of system 100 between the server 102, computing device 106, and communication network 108 allows for the real-time updating of data within the database 104. Service providers can update their listings or information regarding auctions, job postings, or other services, and the server 102 stores these updates in the database 104. Users accessing the system 100 receive current information available through keyword-based search queries. The system 100 handle real-time updates making sure that data stored in the database 104 remains accurate, which is necessary for business-to-business interactions in the automobile market.

In an embodiment, the server 102 processes the search query by performing a search within the database 104 and transmits retrieved data back to the computing device 106. The system 100 is used in business-to-business markets within the automobile industry and supports a range of services selected from auctions, marketing, event management, job postings, transportation, body repair, and financing. Through a unified platform, the system 100 enables data retrieval and interaction between users and automobile-related service providers.

In an embodiment, the keyword-based search query may incorporate a map feature, integrated with said database 104. The map feature allows users to view the geographical locations of automobile services relevant to the keyword-based search query. By incorporating geographical data into the database 104, the system 100 provides a spatial representation of services such as auctions, repair centers, and dealerships. The feature enables users to interact with a dynamic map interface, where service locations can be selected for additional details, such as addresses and contact information. The map feature may comprise filtering options, allowing users to narrow search results based on proximity to their current location or preferred areas. The integration of the map feature within the keyword-based search results allows for seamless navigation between search results and geographic data, providing users with a view of available automobile services.

In an embodiment, the system 100 may act as a virtual office (hereinafter referred as VO) that is dedicated to each user. Said VO allows users to monitor and manage automobile-related activities. A variety of menus and submenus are available within the VO, enabling access to different tasks. Among the available menus is a transaction and invoice menu, which includes three tabs: the transaction notice tab, the invoice tab, and the statement tab. These tabs provide users with access to financial records related to automobile services. Additionally, each user is assigned a virtual bank account that allows for real-time monitoring of financial activities. These activities selected from transactions processed through credit cards, electronic funds transfers (EFT), and pre-authorized debit (PAD). The VO centralizes all financial management activities, making it easy for users to track invoices, receipts, and payments in one location. Users can view detailed transaction histories.

In an embodiment, the system 100 may comprise an automobile auction platform (interchangeably referred as auction platform or platform) that facilitates the auction process through automated notifications. Said auction platform provides real-time updates on the status of user throughout different stages of the auction. A key feature of the platform is the ability to inform users of the remaining time in each auction stage, allowing for well-timed decision-making. The platform also offers users guidance through tasks required for the next stage of the auction process. In addition to providing real-time notifications, the platform incorporates an auto-bidding feature, which enables users to preset a maximum bid. Once the maximum bid is set, the platform automatically submits bids on behalf of the user, without the need for real-time interaction. Bidding stops automatically once the maximum bid is exceeded. Furthermore, said auction platform includes an automated mediation process that helps resolve claims related to undisclosed vehicle damage. The auction process is managed in a structured manner, providing users with all the necessary tools for participating in automobile auctions.

In an embodiment, the system 100 may integrate a geolocation feature within said database 104, allowing users to search for automobile services based on geographical data. The geolocation-based search enables users to pinpoint the location of service providers that match the keyword-based search query. Users can interact with a visual map interface, which displays the locations of various service providers such as dealerships, repair shops, and auction centers. The geolocation feature allows users to filter search results by proximity. Detailed information about service providers, such as addresses and contact information, is displayed on the map for easy access. Users can also navigate the map to view service providers in surrounding areas. The system 100 provides a solution for users looking for geographically relevant automobile services, offering real-time geographic data integrated with the search results.

In an embodiment, the system 100 may provide automobile job posting and application services that allow companies to post job offers related to the automobile industry. Users can view and apply to said job offers without geographical restrictions. The platform simplifies the recruitment process by enabling companies to post job offers in an organized format. Job seekers can browse through available job offers, filter them by criteria such as job type or location, and submit applications directly through the platform. The system 100 also includes a communication feature that enables real-time interaction between companies and job seekers. A chat box is available for companies to communicate directly with candidates, allowing for quick questions, scheduling of interviews, and other recruitment-related discussions.

In an embodiment, the system 100 may comprise services for automobile event promotion, allowing companies to promote events related to automobile launches, internal promotions, and more. Users can search for and view said events, accessing detailed information about the event location, schedule, and participants. The event promotion services include an interface that organizes events by type, allowing users to filter results based on their preferences. Users can explore event details and receive updates regarding important event-related information. Additionally, navigation through said events is made simple through the event promotion service, which presents a user-friendly layout for accessing various automobile-related events. The system 100 also facilitates the promotion of automobile events. Companies can promote their events efficiently, while users can stay updated on launches, promotions, and other relevant automobile events.

In an embodiment, the system 100 may offer automobile transportation and body repair request services. Said services allow users to submit requests for automobile transportation or body repair without geographical limitations. Users can post detailed requests describing the service needed, whether be vehicle transportation or specific body repair work. Service providers can browse through said requests and respond with quotes, providing users with pricing information tailored to their location and service needs. The system 100 also includes a real-time communication feature, where users and service providers can interact through a chat box. The communication allows users to clarify service details, negotiate prices, and finalize service agreements directly with service providers. The transportation and body repair services provide a streamlined platform for connecting users with service providers, offering a centralized place to manage requests, quotes, and communications related to automobile services.

In an embodiment, the system 100 may incorporate automobile financing services, enabling users to submit finance requests for automobile purchases through a digital form. Dealerships can access said finance requests and provide responses to the user through the platform. The system 100 organizes financing requests from multiple dealerships, allowing users to compare various financing options available. The financing process is structured so that dealerships can view and respond to finance requests efficiently, providing users with customized financing plans based on their input. The financing service eliminates geographical barriers, allowing users and dealerships to interact and finalize automobile financing arrangements without restrictions.

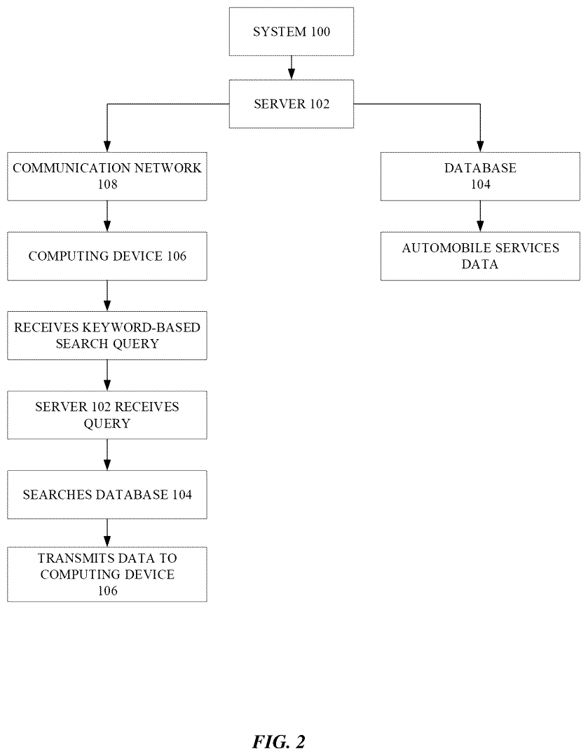

FIG. 2 depicts a process flow diagram of the system 100 for providing a unified platform for automobile-related services, in accordance with the embodiments of the present disclosure. The system 100 comprises a server 102 that connects to a database 104 storing automobile services data, including auction services, marketing, event management, job postings, transportation services, body repair services, and financing services. The server 102 is also connected to a computing device 106 via a communication network 108. The process begins when the computing device 106, operated by a user from a business-to-business (B2B) automobile market, transmits a keyword-based search query to the server 102. The server 102 receives the query and then performs a search within the database 104 to fetch the relevant automobile services data. Once the server 102 retrieves the requested information, the server 102 transmits the data back to the computing device 106 through the communication network 108.

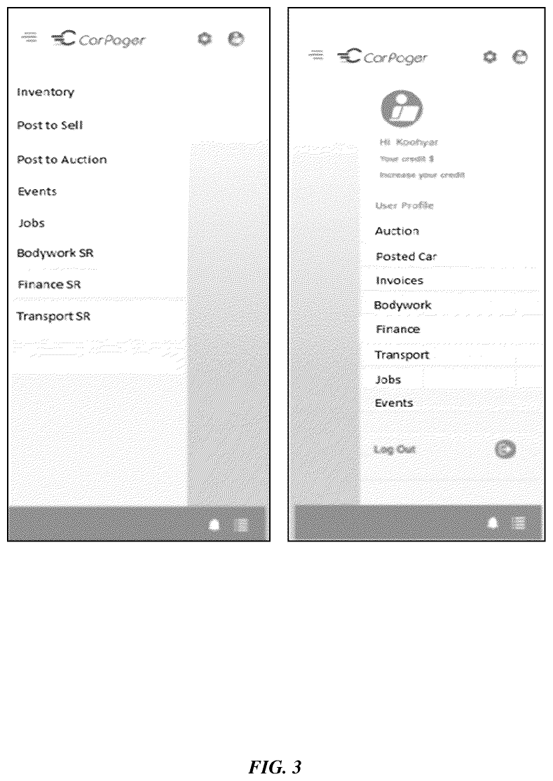

FIG. 3 illustrates an exemplary graphical user interface (GUI) as part of the system 100 for providing a unified platform for automobile-related services. The mobile view depicted in the GUI includes a right menu, a left menu, and a sign-up option. Users can view limited menus without signing in, while signed-in members receive broader access to the system 100. Users may upgrade to premium by filling out a form, choosing a plan, and setting up payment methods. The GUI allows users to view automobiles available for sale or auction without signing in, including functionality for searching, applying filters, viewing details, photos, and accessing location maps, all of which are based on the data stored in the database 104. Users may send messages to sellers for inquiries, and trade-in options are available for dealer-listed cars. Auction participation involves refining searches, selecting deposit modes, and confirming entry. Premium members have simplified auction participation without the need for a security deposit. The GUI interacts with the server 102, which receives keyword-based search queries from the computing device 106 connected via the communication network 108. The server 102 processes the search within the database 104, retrieves relevant automobile data, and transmits the data to the computing device 106. The GUI serves as the interactive interface between the user and the system 100, providing access to automobile auction services, marketing services, event management, job postings, transportation services, body repair, and financing.

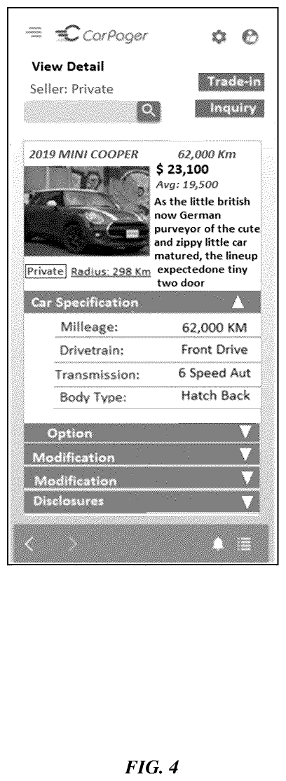

FIG. 4 illustrates an exemplary user interface (UI) depicting multiple automobile related services, in accordance with the embodiments of the present disclosure. The services include automobile auction services, automobile marketing services, automobile event management services, automobile job posting services, automobile transportation services, automobile body repair services, and automobile financing services. Users interact with these services through a graphical user interface (GUI) displayed on the computing device 106.

In an embodiment, to post a car for sale, users must first have an account within the system 100. The process is initiated by selecting the “Post to Sell” option from the GUI. The user is then required to fill out a form and upload the necessary photos and documents associated with the car. Once completed, the car can either be saved to the inventory or marked as a standby listing. These listings appear within the Virtual Office (VO) in the system 100, where they can be managed efficiently. Users can search, sort, edit, or delete their posted car listings within the VO. Deleted listings are archived for one month, and cars that expire after 30 days can either be reposted or removed from the system. Standby listings may be moved to inventory or prepared for auction, and any edits to inventory listings retain the original posting date, while standby edits reflect the current date.

In a preceding embodiment, the system 100 also provides functionality for managing bodywork service requests. Users can create and view bodywork service requests, which are responded to by body shops with quotes. Customers have the option to accept, reject, or negotiate these quotes, and all requests and responses are organized within the VO. Accepted and rejected quotes are categorized into separate tabs. Likewise, body shops can manage their own quotes through the VO, which allows them to view, edit, and track their responses in an organized manner.

In a preceding embodiment, the GUI also supports finance lead management and financing applications. Only dealerships, which are business-to-business (B2B) users, are allowed to purchase finance leads through the system 100. Dealerships can buy finance leads using a credit card or account balance, and these leads are then managed within the “My Finance Leads” section of the VO. Unused leads can be archived for future use. Non-dealership users can apply for financing services only, with no access to purchasing finance leads, only dealerships can purchase finance leads.

In another embodiment, the users can request quotes for transportation services through the system 100. Transport service requests (SR) are visible in the VO of user under the “Transport SR” section. Transporters are the only users allowed to provide quotes in response to these requests. Users can then accept, reject, or negotiate the quotes received. Both users and transporters have separate tabs in their VO to organize accepted and rejected quotes, and transporters can manage and delete quotes as required.

In another embodiment, job posting and application services are also integrated into the system 100. Companies can post job advertisements, while users can search for job offers and apply directly through the GUI. Companies manage their job postings and view applications within the VO, with the ability to accept, reject, or communicate with applicants. Rejected applications are placed into a separate tab, and both companies and applicants can delete unwanted listings. Applicants may only respond to messages transmitted by companies via the chat feature embedded in the system 100. All job-related actions, including tracking job offers and applications, are managed within the VO.

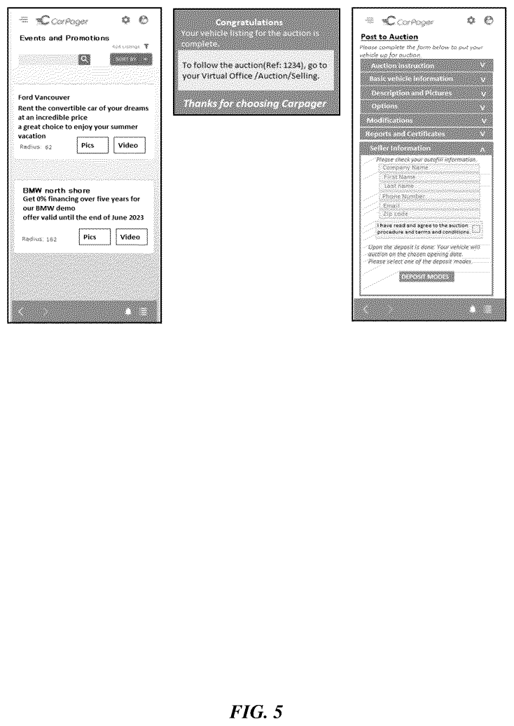

FIG. 5 depicts an exemplary user interface (UI) depicting auction-related services, in accordance with the embodiments of the present disclosure. Users who wish to post vehicles for auction can select the “Post to Auction” option from the left menu of the UI. The form requires users to input details such as basic vehicle information, descriptions, pictures, options, modifications, and reports and certificates. Users must also provide seller information, including company name, personal details, and agreement to the auction terms and conditions. Non-premium users can choose auction dates within the next 48 hours, while Premium Account Users (PAU) can select auction dates up to 15 days in advance. Vehicles scheduled for future auctions by PAU users are placed into the “Wait-to-Launch” (WTL) tab. PAU users can confirm their details and accept the terms without a deposit. If the auction date is more than 48 hours away, the vehicle listing is marked as “Coming Soon,” with a countdown timer appearing 48 hours before the auction starts.

In another embodiment, for non-premium users or those required to provide a deposit, the UI offers two deposit options: “Hold on my Credit Card” or “Freeze on Account.” Upon securing the deposit, users receive a confirmation message through the UI, which allows them to proceed with the auction. Once the auction is listed, users receive a message confirming that their vehicle listing for the auction is complete. The message directs users to their VO under the “Auction/Selling” section to follow the auction progress.

Additionally, the UI includes an “Events and Promotions” section, as shown in FIG. 5, where companies can promote automobile-related events and offers. For example, users can view promotions such as special offers from Ford Vancouver to rent a convertible car or a financing offer from BMW North Shore for 0% financing over five years. Each event or promotion shows the relevant radius for the user and provides options to view pictures or videos for more details.

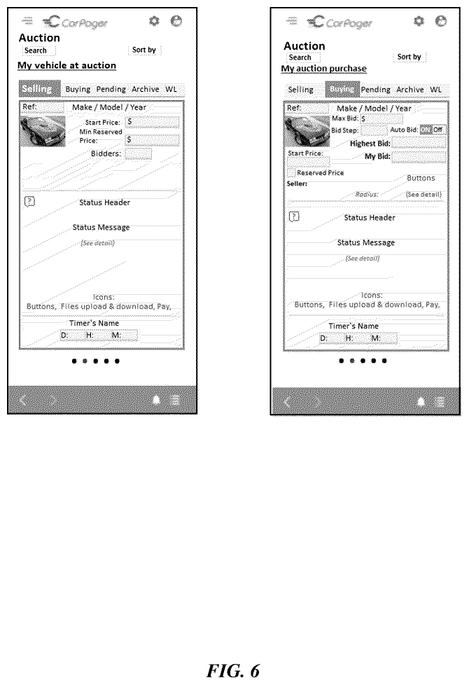

FIG. 6 depicts exemplary user interfaces (UIs) that illustrate the initial procedures involved in the auction process, in accordance with the embodiments of the present disclosure. Users can manage their auctions through the “Selling” tab, where they enter vehicle details such as start price, minimum reserved price, and can monitor the number of bidders. For those participating in auctions, the “Buying” tab allows users to input their maximum bid, observe the highest bid, and activate the “Auto Bid” option. The system handles bid steps and offers seller-related information. Status updates, messages, and auction-related actions such as file uploads, downloads, and payments are managed via the UI, with icons for each task. The countdown timer, located at the bottom of the UI, tracks the remaining time for the auction. The server 102 receives and processes keyword-based search queries, retrieves relevant auction data from the database 104, and transmits the data back to the computing device 106 for real-time auction participation.

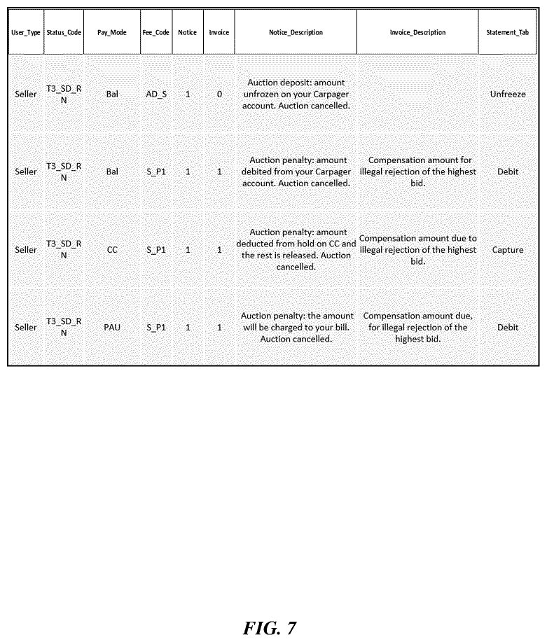

FIG. 7 depicts an exemplary tabular arrangement outlining various seller penalties and deposit statuses in auction transactions, in accordance with the embodiments of the present disclosure. The table illustrates actions taken when sellers fail to submit required documents on time, leading to auction cancellations. Additionally, in the case the seller cancels the highest bid for which reserve price has met, the seller will be charged with penalty. Based on the class of seller and selected deposit mode, penalties are applied. If the auction is cancelled, the deposit is handled accordingly, whether unfrozen, debited from the account of user, or captured from a credit card hold. The notice and invoice descriptions highlight penalties for illegal rejection of the highest bid, with amounts charged directly to the bill or account of seller. Similarly, if buyers fail to make payments within the set deadline, the auction is cancelled, and their deposit is released. Buyers who miss payments are also penalized based on their buyer class and deposit mode.

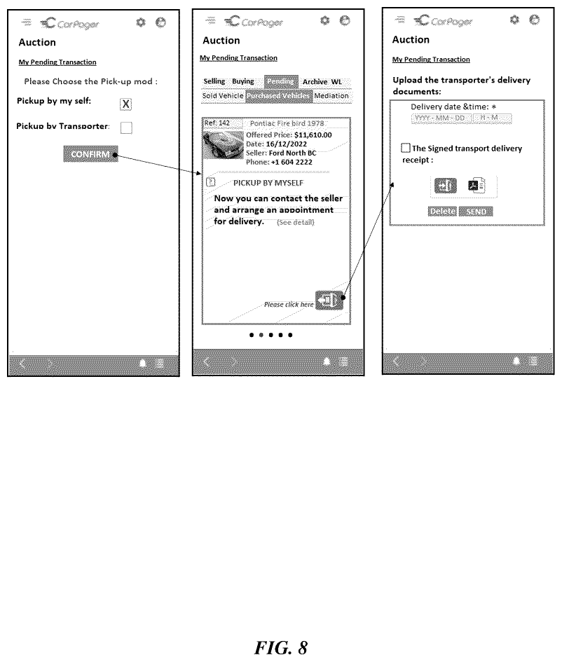

FIG. 8 depicts exemplary user interfaces (UIs) for managing post-auction vehicle pick-up and delivery, in accordance with the embodiments of the present disclosure. Once a vehicle is purchased through the auction, the user is prompted to select the pick-up method via the computing device 106 connected to the server 102 through the communication network 108. Users can choose between “Pickup by myself” or “Pickup by Transporter,” as shown in the first UI. Upon confirmation, if the user selects self-pickup, they are instructed to contact the seller to arrange a delivery appointment, with relevant details shown in the “Pending Transaction” section. If the user selects transporter pickup, the second UI allows them to upload the delivery documents of transporter, including the date and time of delivery and a signed delivery receipt. These documents are uploaded through the UI, where the user can confirm the completion of the transaction.

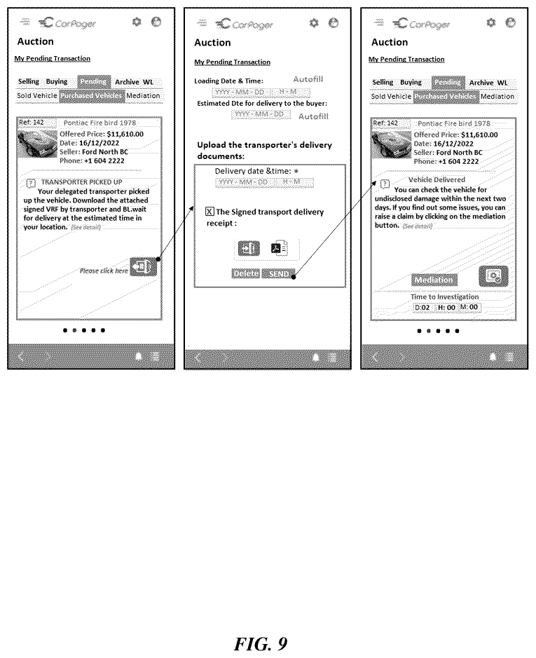

FIG. 9 depicts exemplary user interfaces (UIs) related to vehicle delivery after an auction, in accordance with the embodiments of the present disclosure. The UI, accessible through the computing device 106, allows users to manage post-auction transactions. Once the transporter picks up the vehicle, the user receives a notification, as shown in the first UI, confirming the pick-up and allowing the user to download the signed Vehicle Release Form (VRF) and Bill of Lading (BL). The second UI enables the user to upload the delivery documents of transporter, including the delivery date and time and a signed transport receipt. After the vehicle is delivered, the user is notified via the third UI, allowing the buyer to inspect the vehicle for any undisclosed damages. Should there be any issues, the buyer has the option to raise a claim by selecting the “Mediation” button within a specified timeframe.

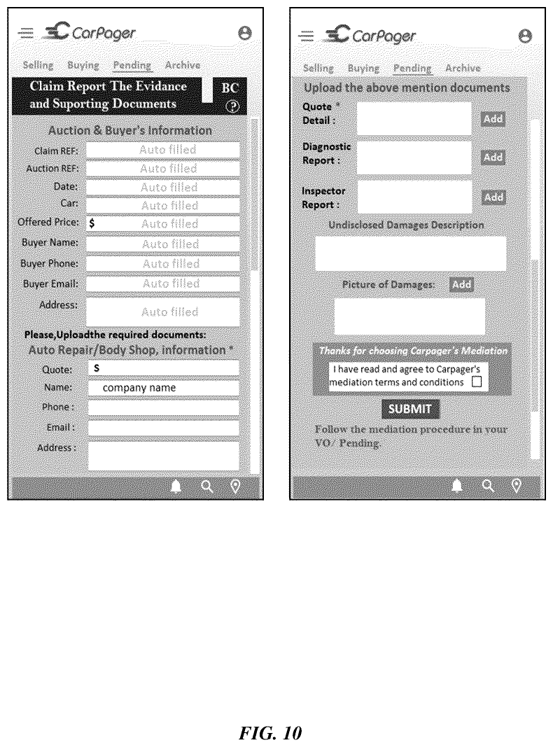

FIG. 10 depicts exemplary user interfaces (UIs) related to the mediation process following an auction, in accordance with the embodiments of the present disclosure. After an auction is completed and the vehicle is delivered, users can file a claim for undisclosed damages through the mediation interface. The computing device 106, operatively connected to the server 102 via the communication network 108, allows users to access pre-filled claim forms with details such as auction reference, offered price, and buyer information automatically populated from the database 104. Users are required to upload relevant documentation, selected from quotes from auto repair shops, diagnostic reports, and inspection results. The form also comprises a section for describing undisclosed damages and uploading photos. The second UI enables users to attach additional supporting documents like pictures of damages and inspection reports before submitting the claim. Upon submission, users agree to the mediation terms and conditions, completing the process.

In an embodiment, the mediation process starts when a buyer submits a report for undisclosed damages. If no report is filed, the seller receives 10 percent of the selling price frozen in the account. If a buyer submits repair costs and pays the mediation fee, the seller is notified. The seller can accept, partially agree, or reject the report. If accepted, repair costs are deducted from the blocked funds belonging to the seller, and the transaction is closed. If a counteroffer is made, negotiations proceed until an agreement or a proposal by the mediator is accepted.

In an embodiment, the mediator determines the compensation for repair costs, which is deducted from the blocked amount of the seller, and the remaining funds are returned to the seller. When mediation is complete, the auction is archived. For the buyer, acceptance of the decision by the mediator credits the agreed amount to the account of the buyer. If the auction is canceled, the return policy outlines responsibility for return costs. Once resolved, all mediation-related matters are archived.

What is claimed is:

1. A system for providing a unified platform for the automobile-related services, the system comprising:
a server comprises a database to store data related to the automobile services, said services are selected from the automobile auction services, the automobile marketing services, the automobile event management services, the automobile job posting services, the automobile transportation services, the automobile body repair services, and the automobile financing services;
a computing device operatively connected to said server via a communication network, wherein the computing device receives a keyword-based search query from a user, wherein the user is selected from a business-to-business (B2B) market type; and
said server:
receives the keyword-based search query from the computing device;
performs the search within the database to fetch the data related to the automobile services; and
transmits the fetched data related to the automobile services to the computing device.

2. The system of claim 1, wherein the keyword-based search query comprises a map feature, such map feature is integrated with said database to display the geographical locations of the automobile services relevant to the keyword-based search query.

3. The system of claim 1, wherein the system further comprises a virtual office dedicated to each user, said virtual office allowing the user to monitor and manage the automobile-related activities, selected from the defined menus and the submenus, wherein said menus comprise a transaction and invoice menu, said transaction and invoice menu further comprising the three tabs selected from a transaction notice tab, an invoice tab, and a statement tab, and wherein a virtual bank account is assigned to each user, said virtual bank account allowing real-time monitoring of the financial activities performed via a credit card, an electronic funds transfer (EFT), or a pre-authorized debit (PAD).

4. The system of claim 1, wherein said services further comprise an automobile auction platform, said auction platform configured to automatically notify a user's status during the auction stages, inform such user of the time remaining until end of an auction stage, and guide the user through the tasks for the next auction stage, wherein said auction platform further comprises an auto-bidding module, said auto-bidding module configured to allow users to set a maximum bid and automatically submit the bids without requiring a real-time user interaction, said auction platform ceasing bidding when the maximum bid is exceeded, and providing an automated mediation process to resolve the claims regarding an undisclosed vehicle damage.

5. The system of claim 1, wherein the system further comprises a geolocation module integrated with said database, such geolocation module configured to enable an open geolocation-based platform allowing the users to locate the automobile services based on geographical data in relation to the keyword-based search query.

6. The system of claim 1, wherein said services further comprise a automobile job posting and the application services, said services configured to allow the companies to post the job offers related to the automobile industry, and the candidates to view and apply to said job offers without the geolocation restrictions, and wherein a communication module provides a chat box for real-time interaction between the companies and the users.

7. The system of claim 1, wherein said services further comprise the automobile event promotion services, said event promotion services configured to allow automobile companies to promote the internal events, the automobile launches, and the promotions, and for the users to search and view said events without the geolocation restrictions, wherein said system facilitates navigation through said events.

8. The system of claim 1, wherein said services further comprise the automobile transportation and body repair request services, said services configured to allow the users to post the automobile transportation or body repair service requests without the geolocation restrictions, and wherein the companies can navigate said requests and provide the location-based quotes, said system further comprising a chat box for real-time communication between the users and the companies.

9. The system of claim 1, wherein said services further comprise the automobile financing services, said vehicle financing services configured to allow the users to submit the automobile finance requests through a digital form, and wherein the dealerships can search, view, and respond to said finance requests without the geolocation restrictions.
